(19) United States
(12) Patent Application Publication
(10) Pub. No.: US 2011/0288982 A1
(43) Pub. Date: Nov. 24, 2011

(54) SYSTEM AND PROCESS FOR TRADING A PHYSICAL COMMODITY

(75) Inventor: Bradford John Georges, Hawthorn (AU)

(73) Assignee: GREENEYE.COM PTY LTD, Richmond, Victoria (AU)

(21) Appl. No.: 13/131,568

(22) PCT Filed: Nov. 27, 2009
(86) PCT No.: PCT/AU09/01550

§ 371 Date: Aug. 15, 2011

(30) Foreign Application Priority Data
Nov. 27, 2008 (AU) 2008906147

(51) Int. Cl. G06Q 40/00

(52) U.S. Cl. 705/37

(57) ABSTRACT

A system for trading a physical commodity that is geographically dispersed or of variable quality, the system including: a market maker component operative to maintain price data representing a buy price and a sell price for trading the commodity being constant with respect to: (i) the pickup and delivery locations of the commodity if the commodity is geographically dispersed; and (ii) the quality of the commodity if the commodity has two or more quality levels; and a trading component operative to receive offer data representing buy and sell offers from a plurality of buyers and sellers of the commodity, the trading component being configured to match each of at least a portion of the buy and sell offers with a corresponding one of the buy price and sell price to execute over-the-counter trades in the commodity with the market maker component.

### TECHNICAL FIELD

The present invention relates to a system and process for trading physical commodities that are geographically dispersed, such as water or greenhouse gas emissions, or commodities for which there are small variations in quality, such as water.

### BACKGROUND

Markets for geographically dispersed physical commodities share a number of common traits and problems. The traits of these markets include:
(i) The availability of the commodity for sale or purchase is spread over a large geographical area with varying degrees of ease of delivery from one location to another; this gives rise to price differentials by location.
(ii) There can also be physical delivery constraints due to transportation or storage factors, such as rail or river capacity, resulting in further price differentials by location.
(iii) Depending on the commodity, the commodity may be available in different qualities such as purity or grade, resulting in yet further price differentials.
(iv) There can be different settlement periods imposed by local regulatory regimes, resulting in even further price differentials, partially because of the time and interest factor, but largely because of the perceived settlement “uncertainty.” For example, in an Australian context, water in the state of South Australia is often priced much lower than water in the state of Victoria because the South Australian seller has to wait months to have his sale formally confirmed, and to receive payment.
(v) In cases where a commodity is spread across a multitude of different market nodes, there can be many different contractual processes, often done differently by different parties.

As a consequence of the factors described above, geographically dispersed physical markets, or markets where the goods have a variety of quality or grade levels (and are therefore split into sub-markets), suffer from many difficulties, including:
(i) prices are localized, fragmented, and generally not transparent.
(ii) each local or sub-market suffers a lack of liquidity; trades are difficult to execute.
(iii) each local or sub-market's limited liquidity also results in wide price spreads that make it more expensive for parties to buy or sell.
(iv) with a multitude of contractual and settlement processes and no economies of scale to reduce transaction costs, trading is cumbersome and expensive.
(v) without market transparency, liquidity or reliable settlement processes, hedging, especially selling forward, does not exist in these markets. Therefore, producers are unable to manage their risk and optimize production, and investors (who could otherwise bring valuable liquidity to the market) stay away.

It is desired to provide a system and process for trading a geographically dispersed physical commodity that alleviate one or more difficulties of the prior art, or at least provide a useful alternative.

### SUMMARY

According to one aspect of the present invention there is provided a system for trading a physical commodity that is geographically dispersed or of variable quality, the system including:
a market maker component operative to maintain price data representing a buy price and a sell price for trading the commodity being constant with respect to:
(i) the pickup and delivery locations of the commodity if the commodity is geographically dispersed; and
(ii) the quality of the commodity if the commodity has two or more quality levels; and
a trading component operative to receive offer data representing buy and sell offers from a plurality of buyers and sellers of the commodity, the trading component being configured to match each of at least a portion of the buy and sell offers with a corresponding one of the buy price and sell price to execute over-the-counter trades in the commodity with the market maker component.

The present invention also provides an electronic market for trading a physical commodity that is geographically dispersed or of variable quality, the market including:
a communications interface operative to receive offer data representing buy and sell offers from a plurality of buyers and sellers of the commodity; and
a market maker component operative to maintain price data representing a buy price and a sell price for trading the commodity, the buy and sell prices being constant with respect to
(i) the pickup and delivery locations of the commodity if the commodity is geographically dispersed; and
(ii) the quality of the commodity if the commodity has two or more quality levels; and
wherein the electronic market is operative to match each of at least a portion of said buy and sell offers with a corresponding one of the buy price and sell price to execute over-the-counter trades in the commodity with the market maker component.

The present invention also provides a process for trading physical commodities, the process being executed by a computer system, and including:
receiving, from a market maker component, price data representing a buy price and a sell price for trading said commodity in a corresponding time period, the buy and sell price being constant with respect to
(i) the pickup and delivery locations of the commodity if the commodity is geographically dispersed; and
(ii) the quality of the commodity if the commodity has two or more quality levels; and
receiving offer data representing buy and sell offers from a plurality of buyers and sellers of the commodity; and
matching each of at least a portion of said buy and sell offers with a corresponding one of the buy price and the sell price to execute over-the-counter trades in the commodity with the market maker.

The present invention also provides a system for trading a physical commodity that has one or more characteristics that separate instances of the physical commodity into two or more classes, each class being associated with a different value for the commodity, the system including:
a market maker component operative to maintain price data representing a buy price and a sell price for trading the commodity, the buy and sell prices being constant with respect to the characteristics:
a trading component operative to receive offer data representing buy and sell offers from a plurality of buyers and sellers of the commodity, the trading component being configured to match each of at least a portion of the buy and sell offers with a corresponding one of the buy price and sell price to execute over-the-counter trades in the commodity with the market maker component.

The present invention also provides a system having components operative to execute the steps of any one of the above processes.

The present invention also provides a computer-readable storage medium having stored thereon programming instructions for executing the steps of any one of the above processes.

### BRIEF DESCRIPTION OF THE DRAWINGS

Preferred embodiments of the present invention are hereinafter described, by way of example only, with reference to the accompanying drawings, wherein:

FIG. 1 is a schematic diagram illustrating prior art fragmented markets for trading a geographically dispersed physical commodity;

FIG. 2 is a schematic diagram illustrating a centralised market enabled by a system for trading a geographically dispersed physical commodity in accordance with one embodiment of the present invention;

FIG. 3 is a block diagram of the system for trading a geographically dispersed physical commodity interconnected with market participants via a communications network such as the Internet; and

FIG. 4 is a block diagram of a trading server of the system for trading a geographically dispersed physical commodity.

### DETAILED DESCRIPTION OF THE PREFERRED EMBODIMENTS

As a consequence of the factors described above, trading of physical commodity that is geographically dispersed, or which has differing quality levels, takes place in fragmented markets and is limited in scope. For example, in Australia the trading of water currently takes place in many localized and largely independent markets, and is mostly limited to irrigators, as represented schematically in FIG. 1, where:
the inner dots 102 represent geographically dispersed irrigators; and the triangles and outer dots 104 represent water contracts between the geographically dispersed irrigators.

Of the approximately 12,000 irrigators in Australia's Murray-Darling Basin, only about 5,000 execute trades, resulting in 15,000 trades per annum in 17 contracts, an average of only 3.5 trades per day per contract.

These irrigators often use brokers and have to wait between 2 and over 40 days for their transactions to complete. The difference between the price at which they can buy and sell (the spread) is often 15% or more, and can even be as high as 40%, plus additional commissions of up to 3%. After committing to a trade, these irrigators are left with uncertainty for days, weeks, or even months until a government water registry confirms their deal. In the interim, their money is often at risk in the bank accounts of small unregulated brokers.

Brokers also suffer tedious bureaucracy, involving substantial paperwork and delays processing trades. There is no single standardised source of up-to-date price data, nor a regular bid and offer of substance—crucial for a liquid and efficient market. Although available in most markets, historical data, charting and technical analysis are not available for the water market, thus handicapping both the irrigator and any potential water investor from making informed decisions. Without standardized contracts, investors and active traders are absent as is the valuable liquidity they would otherwise bring to the markets.

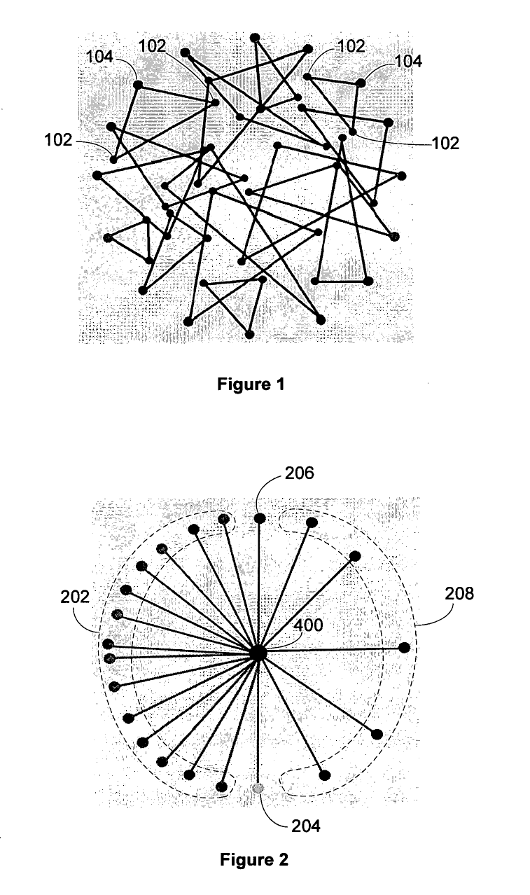

As described herein, a system 400 for trading a physical commodity executes trading processes that enable a centralised marketplace for trading a physical commodity that is geographically dispersed or available in two or more different qualities or grades, by effectively removing many of the barriers that have hitherto hindered such trading, such as those described above. As illustrated schematically in FIG. 2, the system 400 acts as a centralized hub for the marketplace by receiving, processing, generating and sending various types of electronic data to effect trading transactions, whereby the system receives and processes buy and sell offers from buyers and sellers (e.g., irrigators, in the case of a water market) 202 in order to perform trades of the commodity based on one or more standardised contracts. The system 400 communicates with a market maker 204, a secure prime broker/custodian 206, and, where appropriate, registry offices 208, which the system 400 uses to provide instantaneous settlement arrangements.

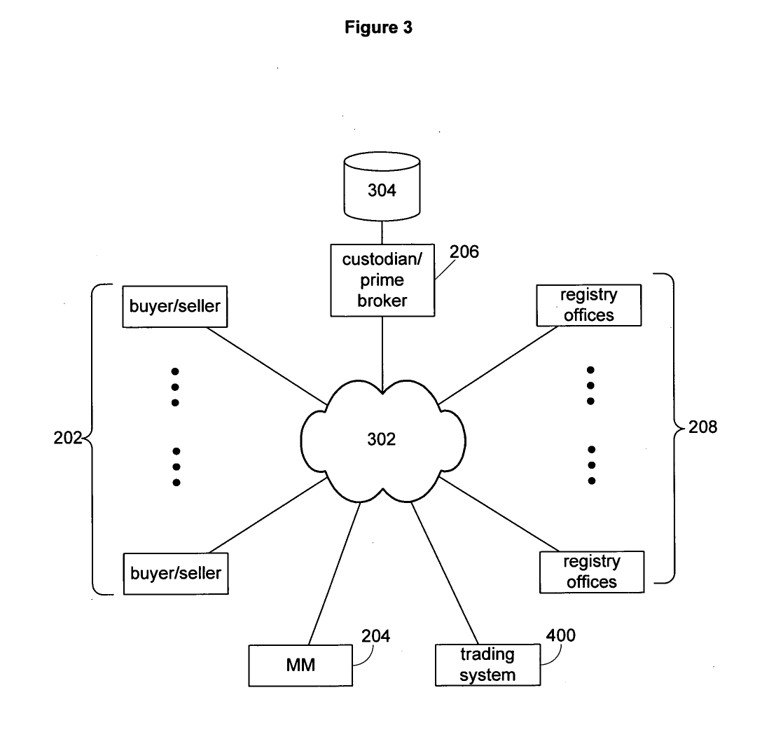

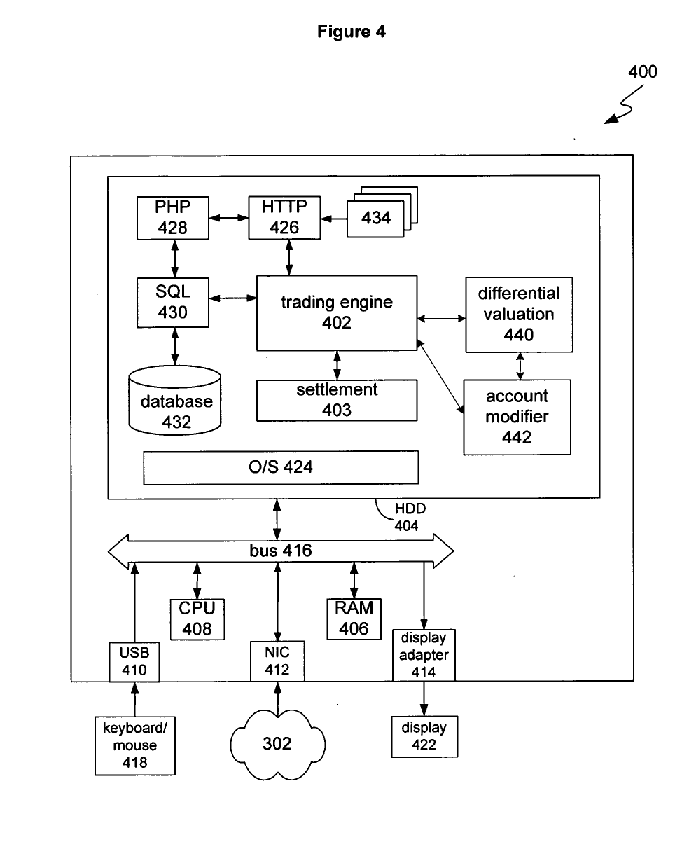

As shown in FIG. 3, the market participants 202 to 208, and the system 400 itself are all computer systems having network interfaces interconnected by a communications network 302 such as the Internet. In the described embodiment, the system 400 includes at least one standard computer system such as an Intel IA-32 or IA-64 based computer system or server, as shown in FIG. 4, and the trading processes executed by the system 400 are implemented as programming instructions of one or more software modules 402, 403 stored on non-volatile (e.g., hard disk or solid-state drive) storage 404 associated with the computer system, as shown. However, it will be apparent that at least parts of the trading processes could alternatively be implemented as one or more dedicated hardware components, such as application-specific integrated circuits (ASICs) and/or field programmable gate arrays (FPGAs), for example.

The system 400 includes standard computer components, including random access memory (RAM) 406, at least one processor 408, and external interfaces 410, 412, 414, all interconnected by a bus 416. The external interfaces include universal serial bus (USB) interfaces 410, at least one of which may be connected to a keyboard 418 and a pointing device such as a mouse 419, at least one network interface connector (NIC) 412 which connects the system 400 to the communications network 302, and a display adapter 414, which may be connected to a visual display device such as an LCD panel display 422.

The system 400 also includes a number of standard software modules 426 to 430, including an operating system 424 such as Linux or Microsoft Windows, web server software 426 such as Apache, available at http://www.apache.org, scripting language support 428 such as PHP (available at http://www.php.net) or Microsoft ASP, and structured query language (SQL) support 430 such as MySQL, available from http://www.mysql.com, which allows data to be stored in and retrieved from an SQL database 432.

Together, the web server 426, scripting language module 428, and SQL module 430 provide the system 400 with the general ability to allow users of the Internet 302 with standard computing devices equipped with standard web browser software to access the system 400.

However, it will be understood by those skilled in the art that the specific functionality provided by the system 400 to such users is provided by scripts accessible by the web server 426, including the one or more software modules 402, 403 implementing the trading processes, and also any other supporting scripts and data 434, including markup language (e.g., HTML, XML) scripts, PHP (or ASP), and/or CGI scripts, image files, style sheets, and the like.

The system 400 provides a centralized and high liquidity market to the market participants 202 to 208 by effectively removing variables that would otherwise fragment the market and provide barriers to trading. In particular, the system 400 removes price variations due to variations in pickup and delivery locations (or variations due to the existence of two or more qualities or grades) of the commodity by effectively trading in a single generalized form of the commodity.

Trades in the commodity may to be considered to be of two types—trades that result in delivery and pickup of the commodity (“delivery trades”), and trades that do not result in delivery (“non-delivery trades”).

By arranging for the marketplace to be an over-the-counter market having a principal market maker 204 who is the counterparty for a very large proportion of the market, price variations such as those arising from differing delivery or supply costs (which only arise in a small proportion of trades, since most trades do not require actual supply or delivery of the commodity) are effectively averaged out over a large number of non-delivery trades, allowing the market maker 204 to provide a single buy price and a single sell price at any given time. This price is constant with respect to the pickup and delivery locations, or quality or grade levels, of the commodity. Thus the market maker 204, through its larger volumes of non-delivery trades, absorbs the risk of settlement for different pickup and delivery locations and/or different qualities or grades of the commodity.

Put another way, because the system 400 effectively combines trading from several heterogeneous markets with disparate delivery, grade or settlement characteristics into a single market of greatly increased liquidity, where the average price differential between these different markets is less than the bid/offer spread of the market maker 204, the market maker 204 can absorb that average differential price risk/cost of a small part of the overall market for delivery, which in itself is but a fraction of the overall trading market into the book of its much larger volume trading book. In this way, the market maker 204 takes advantage of the fact that most trades are non-delivery trades.

To ensure that the market maker 204 can absorb the differential price risk/cost of the market for delivery, its price spread (i.e. the difference between the buy and the sell price) is preferably selected such that the profits made by the market maker 204 are greater than the anticipated losses caused by the differences between the market maker's buy and sell prices, and
(i) buy and sell prices associated with the location at which the commodity is delivered; and
(ii) buy and sell prices associated with the quality level of the commodity for trades that require supply of the commodity.

Notwithstanding the removal of price differences due to location and/or quality or grade from the generalized traded commodity, the system 400 nevertheless preserves the flexibility of fragmented markets by enabling market participants to specify post-trade carry and delivery options in the small proportion of cases where supply of the physical commodity is required, systemically supported by the market maker 204, prime broker 206, and a clearing and settlement facility 403. Trades are executed instantly and settled daily; prices are transparent, as they are published by the market maker 204 and provided to brokers through the trading system 400. Risk is managed in real time by way of the prime broker/custodian 206, preferably being a major bank who acts in place of the market maker 204 as counterparty to all other parties (except for those buyers and sellers 202 held on the books of participating brokers (the latter not being shown in FIGS. 2 and 3 for reasons of clarity)). These features are expected to attract participation in the market, providing high liquidity and reducing costs for the participants.

In order to remove price variations due to variations in quality of the commodity, the system 400 described above trades only in a single quality or type of the commodity. However, in one embodiment, the system 400 provides a plurality of parallel markets, each market trading only one corresponding quality or type of the commodity. Alternatively, the system 400 can be configured to provide a parallel market in which options for different grades or type of the commodity can be bought or sold. Thus although the system 400 of the described embodiment provides only a single market for a single generalised commodity, most generally it can provide a small set of parallel markets to support trades in the actual physical commodity.

The generalised commodity traded by the system 400 is a cash instrument and not a future, and trading system 400 is configured to facilitate high volumes of immediately executed non-delivery trades. As described above, the greater the number of non-delivery trades executed using the system 400 with the market maker 204, the lower the threshold for the spread required to enable the market maker 204 to absorb the potential losses on delivery trades.

To encourage trading, the system 400 includes a differential valuation component 440 for determining, for each buyer and seller 202 who has traded with the market maker and who owns or is committed to sell some of the commodity (but has not yet delivered or taken delivery of it), the change in the total value of the commodity owned by the buyer or seller 202, based on the net movement of the price of the commodity over the trading day. That is, the change in the value of the positions taken by each buyer or seller is determined.

The differential valuation component 440 is connected to an account modification component 442, which debits or credits the account held by the buyer or seller 202 in system 400 according to the calculated change in the total value of the commodity owned or committed by the buyer or seller 202. The differential valuation component 440 and the account modification component 442 enable the system 400 to implement a market similar to a contract-for-differences market, in which positions are purchased using a margin loan facility, with the buyer or seller 202 only responsible for the change in the value of the commodity they own or are committed to sell.

Buyers and sellers contract for cash delivery, but as commonly done by owners of physical commodities, an owner of the generalised commodity can lend or borrow their generalised commodity to and from the market in the same way as can be done using physical commodity, that is, by way of a cash and carry or a sale and repurchase agreement (known colloquially in the art as a “repo”). The market maker 204, by sending rollover rate data through the trading system 400, publishers to buyers or sellers 302 the rollover rate, enabling buyers and sellers 302 to determine the premium or discount they will receive for rolling over their position to the next trading day. The premium or discount may take the form of a credit or debit, or may also take the form of a modification to the value of the position of the buyer or seller, both of these being undertaken by the account modification component 442. Also, the option to specify delivery is only a separate transportation arrangement or appendix that is separate to the generalised commodity.

In order to remove price variations due to variations in contractual processes of the market participants, the system 400 only allows trades where the participants have agreed to be bound by a single set of standardised contracts and settlement terms, which are stored in the database 432. The contracts between the various market participants are summarised in Table 1 below. When a market participant (e.g., a buyer/seller) wishes to set up an account with the trading system 400, the appropriate contracts are retrieved from the database 432 and transmitted to the new participant in the form of web pages transmitted to the participant via the web server 426 of the system 400. The new participant is required to review the standardised contracts and click on a control displayed with the contracts on the web page to indicate the new participant's acceptance of the contract terms. Selection of the button submits this acknowledgement in the form of electronic data that is received by the system 400, and the acknowledgment is stored in the database 432, together with other registration data for the new participant.

The system 400 executes trades using both the market maker 204 and the prime broker 206 with a clearing and settlement facility 403 where all players are bound by a set of standard rules and an arbitration process.

TABLE 1
Contracts between Market Participants

| | TYPES OF CONTRACTS REQUIRED | | | | | | | |
|---|---|---|---|---|---|---|---|---|
| | TO/ | TO/ | O/ | Brkr/ | | | Cust/ | Cust/ |
| Provision | Brkr | MM | TCust | Client | EULA | Assign | Brkr | M [symbol] |
| Spot with T + x settlement where x is (for example) 1-5 business days. | y | y | y | y | | | y | y |
| At the end of each trading day, unless the buyer/seller has prior given notice for imme- | y | y | | y | | | y | y |
| diate settlement (at least 2 hous before margin settlement time), open positions are | | | | | | | | |
| automatically rolled forward by one day, with roll rate debited or credited depending | | | | | | | | |
| Define how (process, e.g. email, electronic, phone, etc.) to give settlement notice. | y | | | y | | | | |
| Roll rates to be set by the market maker. The rate for buyers will not exceed the rate | y | y | | y | | | y | y |
| paid to sellers by more than y % either side of the market rate. | | | | | | | | |
| (y to be a reasonable rate; set cap of 3%) | | | | | | | | |
| Margin agreement requires top up of account based on daily settlement price. | y | | | y | | | y | y |
| Market maker sets margin settlement price at 2PM Eastern Time (Australia) as | y | y | | y | | | y | y |
| its best estimate of the current mid price, taking into account current bids | | | | | | | | |
| and offers and last traded price. [Or average of this price and last traded price] | | | | | | | | |
| Last trading day will be the next to the last business day of May, minus x( [symbol] | y | y | | y | | | y | y |
| X). | | | | | | | | |
| Trading finished two hours early on last trading day with any remaining positions | y | y | | y | | | y | y |
| considered to give notice by default to settle, thereby either taking making delivery | | | | | | | | |
| of a water allocation in T + x days. | | | | | | | | |
| Anyone defaulting on delivery will have to reimburse the custodian [market maker] | y | y | | y | | | y | y |
| for all of his costs plus a 20% penalty. | | | | | | | | |
| If there is a dispute over fair practice in the market maker's settlement process and | y | y | | y | | | y | y |
| penalty of more than $20,000 then the issue can be taken to an appeals board of three | | | | | | | | |
| industry professionals, appointed by greeneye.com and approved by the custodian. | | | | | | | | |
| Market Maker has 3 day ‘grace’ on physical delivery | y | y | | y | | | y | y |
| First trading day of each year's allocations is first trading day of April of earlier year | y | y | | | | | y | y |
| Custodian may set minimum client margin requirements of 40% or more for last | | | | | | | | |
| week of trading | | | | | | | | |

TO = Trading System Operator
MM = Market Maker
Cust = Custodian
EULA = End User Licence Agreement
Brkr = Broker [symbol]
indicates data missing or illegible when filed

As described above, commodity location and quality/grade levels are standardized, but both the buyer and seller 202 have the option to specify a variation to the delivery location or quality/grade. The prime broker 206 can alter the delivery location by providing sufficient notice to the buyer/seller 202. This notice takes the form of an alteration to a web page stored in database 432 and served by the web server 426, as described above in relation to the transmission of contracts to the buyer/seller 202. Where elected delivery locations create market constraints, delivery allocations are determined by predetermined rules. For example, if a Water Authority alters delivery locations or pricing, a lottery can be used to allocate delivery. Arbitration procedures are outlined clearly and further support the delivery process. A standard fixed fee is set for different delivery options. For example, in the case of a water market, these fees reflect the costs imposed by the water authorities and any private delivery channels.

Each trade made by the system 400 involves a contract for the traded commodity with settlement in a period of day(s) specified in the contract between the trader and the prime broker 206. The seller has the option to deliver at any one of a list of approved delivery locations, which can updated by the market maker 204 and/or the prime broker 206 by modifying a web page as further described above. The market maker 204 has the option to impose a supplementary delivery charge for locations where a strong price premium is emerging, by giving notice to the buyer. The full amount of such premium is awarded to the seller who ultimately provides the commodity at that delivery location. Similarly, the buyer has the option to request delivery at any of the list of approved delivery locations, as above, with notice.

Trading is standardized as “spot” like any “cash” physical market, but the buyer and the seller both have the option to elect the actual delivery date, paying or receiving daily interest or lending costs. In the water market, the buyer has the option to elect the delivery date but the settlement and payment date follow directly from the trade (the actual settlement and payment date depending on the relevant State Water Authorities).

The standardization of location and time, and the options provided to both parties to vary the time and location of delivery after the trade, as described above, are facilitated, mediated and dependent on the standardised contract, market maker 204, prime broker 206 and trading system 400.

Positions held by a dispersed base of buyers and sellers who registered with Government Registries that do not have automated computer interfaces are held in a “Shadow Registry™”, being a database 304 of the prime broker 206 so that all the positions and collateral of market participants can be known to an approved party such as their broker, so that transactions with other parties can be executed immediately, and so that brokers and clients can assess their open positions, open trade profits and losses, margin requirements and net free balances, and so that relevant parties can assess and manage risk in real time.

The system 400 thus enables the limited trading of existing multiple markets to be replaced with a single, more liquid centralised marketplace with greater price transparency and lower dealing costs, by effectively removing heterogeneous market features and the heterogeneous requirements of the market participants. The system 400 provides a centralised marketplace that facilitates trading, whereby those with excess water can readily sell it or lend it to the marketplace and those requiring more water can readily buy or borrow it.

TABLE 2
Feature Comparison of the Centralised
Market and other types of Market

| | Spot | Future | CFD | “Abstract” |
|---|---|---|---|---|
| 1 day Settlement/auto rollover CFD | | | x | x |
| Standard ‘grade’ (Vic fungible) | | | x | x |
| Seller option for delivery | | x | | x |
| Buyer option for delivery (backed | | | | x |
| by MM)* | | | | |
| FND | | x | | |
| LTD | | x | | |
| Bundled fixed price ‘basis’ or | | | | x |
| insurance* | | | | |
| Override auto rollover by noon & | | | | x |
| Market | | | | |
| maker option 3 day grace on delivery | | | | |
| Maximum position over | | | | x |
| entitlement = 20 GL | | | | |
| Instantaneous Settlement | | | | x |
| (backed by MM)** | | | | |
| Avoids cost of registry on most deals | | | | x |
| Avoids “basis” cost on most deals | | | | x |
| Makes delivery the exception rather | | x | x | x |
| than rule | | | | |

*Due to high volume of 2way trade, this insurance becomes cheap to offer, as delivery is rare
**Market Maker may need to keep some water in account(s) for delivery

The matching of buyer and seller offers with the corresponding price set by the market maker 204 is performed by a trading engine 402 of the system 400, as shown in FIG. 4. Once the matching has been performed, the information on the trade (including the buyer/seller's identity, the trade price, trade volume, and timestamp) is stored in the database 432, and further processing is performed by a settlement component 403.

As described above, the system 400 also provides the following features and advantages:
(i) it enables margined or collateralized trading in a geographically dispersed commodity;
(ii) it enables short selling (similar to a contract-for-differences market);
(iii) through collateralized/margined accounts with suitable regulatory status, it enables traders to buy and/or sell the commodity without having physical positions or the ability to take delivery;
(iv) it provides a database which records assignment or inventory holdings of trader physical positions. This database also enables participating brokers to have access to the value of that position for the purpose of risk management and enabling trading positions to be taken against such values;
(v) it provides a sale and repurchase (repo) facility to enable holders of the physical commodity to lend their supply to the market on a short term basis for a fee, without losing the market upside of their underlying physical position;
(vi) it multiplies the trading volume by bringing in new participants, by enabling short selling/hedging, by enabling margined trading and faster settlement, with only a fraction of the trades going to deliver; and
(vii) with sufficient trading volume, it greatly reduces spreads and other transaction costs, with some trades requiring no delivery/registry charges, with most trades occurring in one rather than many markets and with a centralized market maker.

The system 400 thus provides many advantages over the prior art for trading physical commodities that are geographically dispersed or of variable qualities or types. In particular, it provides price transparency, concentrated trading, increased liquidity, and tighter bid/offer spreads that all contribute to reduced transaction costs; clear, reliable, quick and efficient settlement; and potential for short selling and sell hedging by producers. These benefits will encourage investor participation, which further increases market liquidity and the ability for trades to occur more easily and with lower costs. The system 400 thus enables a more efficient market that allocates scarce resources such as water more efficiently.

Where the system 400 is used to facilitate trading in water, water culture will change from where it is considered infinite and cheap to where water is considered valuable and limited. The system 400 allows the market to set the value of water depending on its scarcity, leading to natural adjustments in water use. As water prices increase with scarcity, short, medium, and long term capital will emerge to fund new solutions for water treatment, purification, delivery, and recycling.

Irrigators, other water users and mainstream retail and wholesale brokers will increasingly seek access to a tradable water market. The system 300 provides access to such a market.

Although embodiments of the present invention have been described above largely in the context of water trading, it will be apparent to those skilled in the art that the invention can equally be applied to other physical commodities that are geographically dispersed or have two or more quality levels, such as greenhouse gas emissions, for example.

Many modifications will be apparent to those skilled in the art without departing from the scope of the present invention as hereinbefore described with reference to the accompanying drawings.

1. A system for trading a physical commodity that is geographically dispersed or of variable quality, the system including:
a market maker component operative to maintain price data representing a buy price and a sell price for trading the commodity, that is constant with respect to:
(i) the pickup and delivery locations of the commodity if the commodity is geographically dispersed; and
(ii) the quality of the commodity if the commodity has two or more quality levels; and
a trading component operative to receive offer data representing buy and sell offers from a plurality of buyers and sellers of the commodity, the trading component being configured to match each of at least a portion of the buy and sell offers with a corresponding one of the buy price and sell price to execute over-the-counter trades in the commodity with the market maker component.

2. A system as claimed in claim 1 wherein the commodity is traded as a cash instrument.

3. A system as claimed in claim 1 wherein all market participants are bound by a standardised set of trade contracts.

4. A system as claimed in claim 1 wherein the trading component is operative to generate trading data representing said trades, and to send the trading data to a prime broker computer so that the prime broker computer acts in place of the market maker component as a counterparty to every trade represented by the trading data.

5. A system as claimed in claim 4 wherein the prime broker computer is a part of a household name custodian, thereby providing instantaneous settlement and risk management.

6. A system as claimed in claim 1, further including a differential valuation component for calculating, for each buyer and seller who has traded with the market maker component and who owns or has committed to sell some of the commodity but has not yet delivered or taken delivery of it, a change in the total value of the owned or committed commodity based on the net movement of the price of the commodity over a trading day.

7. A system as claimed in claim 6 wherein the trading component includes an account modification component for debiting or crediting an account held by the buyer or seller according to the calculated change in the total value of the owned or committed commodity.

8. A system as claimed in claim 7 wherein the account modification component is configured to modify the account held by a buyer or seller according to rollover rate data received from the market maker component.

9. A system as claimed in claim 1 wherein the trading component is connected to a wide-area computer network, the trading component being configured to enable buyers or sellers to trade in the commodity using a computer terminal remote from the trading component and connected to the computer network.

10. A system as claimed in claim 1 wherein the trading component is configured to execute trades where the prime broker computer is the counterparty immediately upon request by buyers or sellers.

11. An electronic market for trading a physical commodity that is geographically dispersed or of variable quality, the market including:
a communications interface operative to receive offer data representing buy and sell offers from a plurality of buyers and sellers of the commodity; and
a market maker component operative to maintain price data representing a buy price and a sell price for trading the commodity, the buy and sell prices being constant with respect to:
(i) the pickup and delivery locations of the commodity if the commodity is geographically dispersed; and
(ii) the quality of the commodity if the commodity has two or more quality levels; and
wherein the electronic market is operative to match each of at least a portion of said buy and sell offers with a corresponding one of the buy price and sell price to execute over-the-counter trades in the commodity with the market maker component.

12. A process for trading physical commodities, the process being executed by a computer system, and including:
receiving, from a market maker component, price data representing a buy price and a sell price for trading said commodity in a corresponding time period, the buy and sell price being constant with respect to
(i) the pickup and delivery locations of the commodity if the commodity is geographically dispersed; and
(ii) the quality of the commodity if the commodity has two or more quality levels the pickup and delivery locations of the commodity; and
receiving offer data representing buy and sell offers from a plurality of buyers and sellers of the commodity; and
matching each of at least a portion of said buy and sell offers with a corresponding one of the buy price and the sell price to execute over-the-counter trades in the commodity with the market maker.

13. A process as claimed in claim 12 further including calculating, for each buyer and seller who has traded with the market maker and who owns or has committed to sell some of the commodity but has not yet delivered or taken delivery of it, a change in the total value of the owned or committed commodity based on the net movement of the price of the commodity over a trading day.

14. A process as claimed in claim 13 further including debiting or crediting an account held by the buyer or seller according to the calculated change in the total value of the owned commodity.

15. A process as claimed in claim 13 further including the step of debiting or crediting an account held by the buyer or seller according to rollover rate data received from the market maker component.

16. A process as claimed in claim 12 further including receiving requests to buy or sell the commodity generated by a buyer or seller using a computer terminal remote from the computer system, and sent using a wide-area computer network.

17. A system having components operative to execute the steps of claim 12.

18. A non-transitory computer-readable storage medium having stored thereon programming instructions for executing the steps of claim 12.

19. A system for trading a physical commodity that has one or more characteristics that separate instances of the physical commodity into two or more classes, each class being associated with a different value for the commodity, the system including:
a market maker component operative to maintain price data representing a buy price and a sell price for trading the commodity, the buy and sell prices being constant with respect to the characteristics; and
a trading component operative to receive offer data representing buy and sell offers from a plurality of buyers and sellers of the commodity, the trading component being configured to match each of at least a portion of the buy and sell offers with a corresponding one of the buy price and sell price to execute over-the-counter trades in the commodity with the market maker component.
